(19) United States
(12) Patent Application Publication
(10) Pub. No.: US 2024/0322491 A1
(43) Pub. Date: Sep. 26, 2024

(54) CONNECTOR ARRANGEMENT

(71) Applicant: Yazaki Europe Ltd., Basildon (GB)

(72) Inventor: Mario MANDIR, Zagreb (HR)

(73) Assignee: Yazaki Europe Ltd., Basildon (GB)

(21) Appl. No.: 18/608,215

(22) Filed: Mar. 18, 2024

(30) Foreign Application Priority Data
Mar. 20, 2023 (EP) 23162964.3

(51) Int. Cl. H01R 13/639; H01R 13/05; H01R 13/627; H01R 13/641; H01R 13/66

(52) U.S. Cl. CPC H01R 13/639; H01R 13/05; H01R 13/6271; H01R 13/641; H01R 13/6683; H01R 13/6691

(57) ABSTRACT

A connector arrangement comprising a connector and a corresponding mating connector configured to be mated with the connector, a CPA member configured to be movable between an open state and a closed state, wherein in the closed state the CPA member is adapted to confirm a proper mating of the connector and the mating connector and prevents the connector and the mating connector from accidental unmating, and a detection device for detecting the closed state of the CPA member, the detection device comprising an electric circuit.

### BACKGROUND OF THE INVENTION

### Field

The present application relates to a connector arrangement comprising a connector and a corresponding mating connector configured to be mated with the connector, a CPA member configured to be movable between an open state and a closed state, wherein in the closed state the CPA member is adapted to confirm a proper mating of the connector and the mating connector and prevents the connector and the mating connector from accidental unmating, and a detection device for detecting the closed state of the CPA member, the detection device comprising an electric circuit.

### Background

The Connector Position Assurance (“CPA”) member of a connector arrangement is provided to assure that an electrical connector is fully mated. A CPA member is a secondary lock that cannot be engaged until the connector is fully mated. To further prove that the CPA member is properly installed and deployed, electrical circuits like Radio-Frequency Identification (“RFID”) tags are used.

U.S. Pat. No. 11,522,319 B2 discloses an RFID-enabled electrical connector with connector position assurance features. The RFID tag is only readable after the CPA features have been fully deployed. The electrical connector is comprised of at least two parts, a socket and a plug. A connector housing is positioned between the socket and plug, with both the socket and plug connecting to the connector housing. Until the CPA feature has been fully deployed, the RFID tag is covered by an electrically conductive material, preferably an electrically conductive plastic. The RFID tag can only be properly read after the CPA feature has been fully deployed.

With a covered RFID tag, signal leakage can become an issue.

It can be an objective to provide a connector arrangement comprising a CPA member and a detection device with an electric circuit that is switchable.

### SUMMARY OF THE INVENTION

The objective is accomplished by the connector arrangement as claimed. Embodiments are described in the dependent claims.

The connector arrangement comprises a connector and a corresponding mating connector configured to be mated with the connector, a CPA member configured to be movable between an open state and a closed state, wherein in the closed state the CPA member is adapted to confirm a proper mating of the connector and the mating connector and prevents the connector and the mating connector from accidental unmating. The connector arrangement further comprises a detection device for detecting the closed state of the CPA member, the detection device having an electric circuit and a spring contact for connecting and disconnecting the electric circuit, the spring contact comprising a resilient member, or at least one resilient member, wherein the resilient member is deflected by at least one of the connector and the mating connector when the CPA member is moved from the open state to the closed state, and wherein the resilient member comprises a conductor section of the electric circuit.

The detection device having an electric circuit and a spring contact for connecting and disconnecting the electric circuit advantageously allows to switch the detection device on and off. A change of state of the electric circuit by connecting or disconnecting the electric circuit can thus indicate that the CPA member has been moved from the open state to the closed state. The electric circuit may comprise at least one of a transmission antenna and a logic block for wirelessly indicating that the CPA member has been moved from the open state to the closed state. The electric circuit may particularly comprise an RFID tag and an RFID antenna. Connecting and disconnecting the electric circuit may thus result in activating or deactivating one or both of the transmission antenna and the logic block, or altering an information transmitted by the transmission antenna and the logic block. An operator or supervisor can thus be notified that the CPA member has been moved from the open state to the closed state, which indirectly also confirms that the connector is properly mated with the mating connector. The notification may further be recorded for verification purposes.

The connector and corresponding mating connector are generally used to establish an electrical connection, for example a high voltage connection. CPA member designates a connector position assurance member, which is a secondary lock of the connector arrangement that cannot be engaged until the connector and the mating connector are properly mated. The open state and closed state of the CPA member describe a position of the CPA member, the open state meaning that the CPA member is not engaged and the closed state meaning that the CPA member is engaged, confirming the proper mating of the connector and the mating connector and preventing the connector and the mating connector from accidental unmating. The detection device for detecting the closed state of the CPA member may also be described as detecting the state of the CPA member, whether it is closed or open. The resilient member of the spring contact has the advantage that a spring tension due to deflection holds the electric circuit in either the connected or the disconnected state. The resilient member comprising a conductor section of the electric circuit means that the resilient may be the conductor section or the conductor section can be attached to the resilient member.

According to an embodiment, the detection device can be arranged on the CPA member only. The detection device can be a modular member, which is connected to the CPA member, for example by means of a snap fit connection. Alternatively, the detection device can be integrated in the CPA member. Furthermore alternatively, the detection device can be partly arranged on the connector and on the CPA member.

According to a further embodiment, the electric circuit can have two contact portions electrically isolated from each other, the resilient member being adapted to bridge the two contact portions, with the conductor section connecting or disconnecting the electric circuit when the CPA member is in the closed state. The spring tension of the deflected resilient member can press the conductor section onto the two contact portions or away from the two contact portions when the CPA member is in the closed state. The two contact portions can be arranged on the connector and the resilient member can be arranged on the CPA member. In particular, the electric circuit can at least in part be disposed on a circuit board, with the circuit board being arranged on the connector. The two contact portions, which are connected to the electric circuit on the circuit board, can be attached to a latching arm of the connector.

According to a further embodiment, the resilient member can have two legs, the conductor section extending from one leg to the other leg, each leg being adapted to contact one of the two contact portions with the conductor section.

According to a further embodiment, the detection device can have two resilient members, each resilient member comprising a conductor section of the electric circuit. The electric circuit can have an electrically isolated contact bridge, the resilient members being adapted to bridge the two conductor sections by contacting the contact bridge with both conductor sections, thus connecting or disconnecting the electric circuit when the CPA member is in the closed state. The spring tension of the deflected resilient members can press the conductor sections onto the contact bridge or away from the contact bridge when the CPA member is in the closed state.

According to a further embodiment, the two resilient members can be arranged on the connector and the contact bridge can be arranged on the CPA member. The electric circuit can be at least in part disposed on a circuit board, the two resilient members being attached to the circuit board, and the circuit board being arranged on the connector.

At least one of the one or two conductor sections, the bridge portion and the contact portions of the described embodiments can be provided as an electrically conductive paint or foil. The resilient member can be an electrically conductive spring, for example a metal spring forming the conductor section or sections. The resilient member can be a solid metal wire or a flat metal wire.

### BRIEF DESCRIPTION OF THE DRAWINGS

The invention is described in more detail with respect to the attached drawings. The illustrations are exemplary and do not restrict the scope of the invention.

In the Figures:

FIG. 1 shows a connector with a CPA member of a first embodiment of a connector arrangement in a perspective view;

FIG. 2 shows a connector with a CPA member of a first embodiment of a connector arrangement in an exploded perspective view;

FIGS. 3 and 4 show a detection device of the CPA member of FIG. 1 in different views;

FIGS. 5 and 6 show the first embodiment of the connector arrangement with the CPA member in an open state and in a closed state in sectional views;

FIG. 7 shows the connector with the CPA member of a second embodiment of a connector arrangement in a perspective view;

FIGS. 8 and 9 show the detection device and CPA member of FIG. 7 in different states in perspective views;

FIGS. 10 and 11 show the detection device and CPA member of FIG. 7 in different states in side views;

FIG. 12 shows a detail of a third embodiment of the connector arrangement in a perspective view;

FIG. 13 shows a detail of the embodiment of FIG. 12;

FIG. 14 shows the CPA member of a fourth embodiment of the connector arrangement in a perspective view;

FIGS. 15 and 16 show the connector of the fourth embodiment in different perspective views;

FIGS. 17 and 18 show the fourth embodiment of the connector arrangement with the CPA member in the open state and in the closed state in sectional views;

FIG. 19 shows the connector with the CPA member of a fifth embodiment of the connector arrangement in a sectional view;

FIG. 20 shows the CPA member of FIG. 19 in a perspective view;

FIG. 21 shows the fifth embodiment of the connector arrangement with the CPA member in the closed state in a sectional view;

FIGS. 22 to 24 show a detection device of a sixth embodiment in different views;

FIG. 25 shows a detail of the detection device of FIG. 22;

FIGS. 26 to 28 show the CPA member of the sixth embodiment with and without the detection device in different views;

FIGS. 29 and 30 show the sixth embodiment of the connector arrangement with the CPA member in the open state and in the closed state in sectional views.

### DETAILED DESCRIPTION

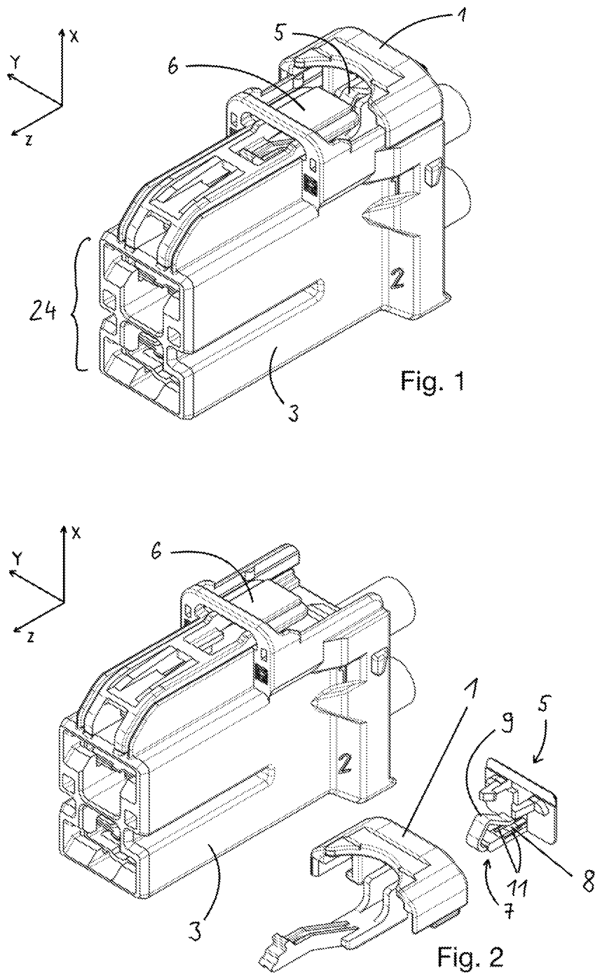

In FIG. 1 a connector 3 with a CPA member 1 of a first embodiment of a connector arrangement is depicted in a perspective view. The connector 3 is also depicted in FIG. 2, in an exploded perspective view. The FIGS. 1 and 2 are described together. The CPA member 1 is configured to be movable between an open state shown in FIG. 1 and a closed state, and a latching arm 6 of the connector 3 is configured to interact with the CPA member 1 when the CPA member 1 moves from the open state to the closed state, which is described below. A detection device 5 for detecting the closed state of the CPA member 1 is installed on the CPA member 1. The connector 3 has terminal reception section 24 for accommodating electric terminals (not shown). The terminal reception section 24 is largely omitted in the following illustrations of the connector 3. Where applicable in the following Figures, arrows X, Y and Z illustrate three orthogonal directions in space according to Cartesian coordinates.

The detection device 5 comprises an electric circuit 8 and a spring contact 7 for connecting and disconnecting the electric circuit 8. The spring contact 7 comprises a resilient member 9, for example a metal spring. The electric circuit 8 has two contact portions 11 electrically isolated from each other, and the resilient member 9 is adapted to bridge the two contact portions 11 when it is deflected, thus connecting the electric circuit 8. The resilient member 9 then forms a conductor section of the electric circuit. However, the resilient member can alternatively carry the conductor section, for example if the resilient member 9 is of dielectric material with an electroconductive bridge attached to it.

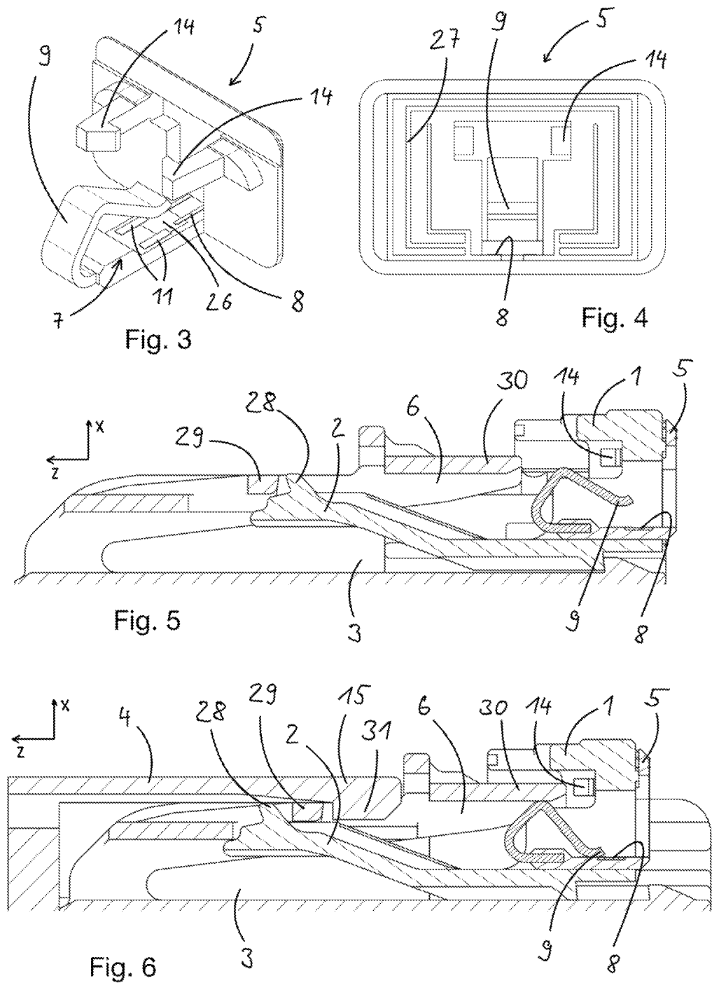

In FIGS. 3 and 4 the detection device 5 of the CPA member 1 is depicted in different views. The FIGS. 3 and 4 are described together. In the depicted embodiment, the detection device 5 is arranged on the CPA member 1 only. Further, the detection device is modular member, which is attached to the CPA member 1 by means of locking clips 14 or other suitable means. The electric circuit 8 comprises a transmission antenna 27, for example an RFID antenna, which is attached on a surface of the modular detection device 5, which faces away from the CPA member 1 when installed to enhance a reception quality for wireless transmission. The electric circuit 8 may further comprise a logic block 26, for example an RFID tag.

The detection device 5 is adapted to wirelessly indicate that the CPA member 1 has been moved from the open state to the closed state, which will be described with respect to FIGS. 5 and 6, which show the first embodiment of the connector arrangement with the CPA member 1 in the open state in FIG. 5 and in the closed state in FIG. 6, each depicted in a sectional view in a plane defined by the X and Z spatial directions. The connector 3 is only partly depicted as the terminal reception section 24 has been omitted. The same applies to a mating connector 4, which is configured to be mated to the connector 3. In the unmated position of the connector arrangement shown in FIG. 5, the CPA member 1 cannot be moved from the open state to the closed state, because an arm 2 of the CPA member 1 has a protrusion 28 that is blocked by a beam 29 on the latching arm 6. The resilient member 9 of the detection device 5 is unbent and a clearance between the resilient member 9 and the contact portions 11 of the electric circuit 8 prevents a premature closing of the electric circuit 8.

To reach the mated position of the connector arrangement shown in FIG. 6, with the CPA member 1 still being in the open state shown in FIG. 5, the mating connector 4 is attached to the connector 3 by inserting the connector 3 in Z-direction into the mating connector 4. A locking arm 15 on the mating connector 4 deflects the latching arm 6 of the connector 3 and the arm 2 of the CPA member 1 against the X-direction during the mating process until the latching arm 6 is free to snap back towards the locking arm 15, i.e. when the beam 29 has passed a head 31 of the locking arm 15, which has an increased extension in the X-direction than the rest of the locking arm 15. The latching arm 6 snaps into a position establishing a positive form locking in the Z-direction between the head 31 of the locking arm 15 and the beam 29. During the mating process, a free end 30 of the latching arm 6 stays clear of the resilient member 9, which is still unbent. In the mated position, the head 31 of the locking arm 15 only deflects the arm 2 of the CPA member 1 against the X-direction and as the latching arm 6 has returned to its initial position, the protrusion 28 is no longer blocked by the beam 29. Only then can the CPA member 1 move in Z-direction from the open state to the closed state.

When the CPA member 1 has reached the closed state, as depicted in FIG. 6, the arm 2 is released and the protrusion 28 is located in the Z-direction on the opposite side of the beam 29 than before. If the CPA member 1 is moved back towards the open position, the arm 2 is again deflected. As the CPA member 1 can only be moved into the closed position when the connector 3 and the mating connector 4 are properly mated, the detection device 5 indirectly indicates that that the connector 3 and the mating connector 4 are properly mated when the closed position of the CPA member 1 is detected and indicated. By moving the CPA member 1 into the closed state, the resilient member 9 is deflected by the free end 30 of the latching arm 6 and the clearance between the resilient member 9 and the contact portions 11 of the electric circuit 8 is reduced until the resilient member 9 is pressed onto the contact portions 11 of the electric circuit 8, thus closing the electric circuit 8. As the free end 30 of the latching arm 6 is blocked by the resilient member 9 in the X-direction, the CPA member 1 prevents the connector 3 and the mating connector 4 from accidental unmating. The two contact portions 11 are electrically isolated from each other. The resilient member 9 bridges the two contact portions 11 thus connecting the electric circuit 8. The change of state of the electric circuit 8 by connecting the electric circuit 8 indicates that the CPA member 1 has been moved from the open state to the closed state, in particular by sending a signal via the transmission antenna 27, which has been generated by the logic block 26. In an alternative embodiment, the change of state of the electric circuit 8 can be a discontinuation of the electric circuit 8, and the end of transmission of the signal indicates the closed state of the CPA member 1.

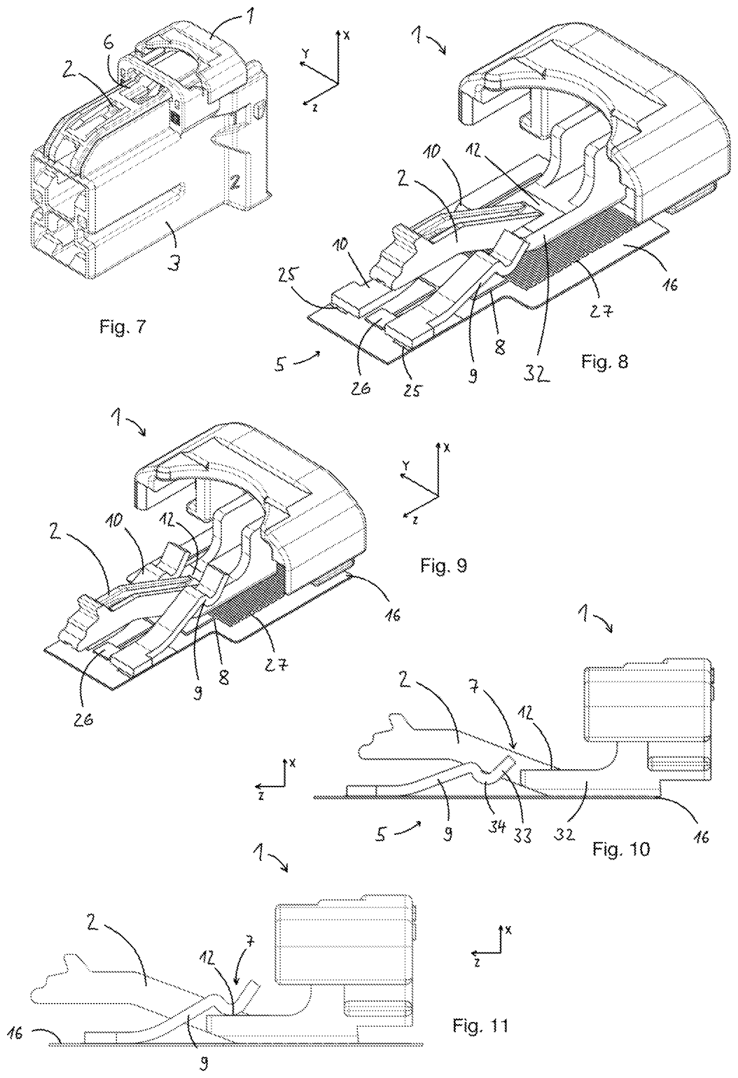

In FIG. 7, the connector 3 with the CPA member 1 of a second embodiment of the connector arrangement is depicted in a perspective view. The CPA member 1 is in the closed state with the arm 2 engaged with the latching arm 6. The person skilled in the art is aware that thus the connector arrangement is in the mated state although the mating connector 4 is not depicted. The FIGS. 8 to 11 show the CPA member 1 and the detection device 5 in different views. The detection device 5 of this embodiment is partly arranged on the connector 3 and on the CPA member 1. The connector 3 is not depicted. The electric circuit 8 is in part disposed on a circuit board 16, which is arranged on the connector 3. The detection device 5 has two resilient members 9, 10 comprising a conductor section of the electric circuit 8. In the depicted embodiment, the two resilient members 9, 10 are electroconductive springs, which are connected to the electric circuit via contact pads 25. The electric circuit 8 has an electrically isolated contact bridge 12, which is arranged on a plate member 32 of the CPA member 1. The contact bridge 12 can be a metal plate or an electroconductive coating in the form of a foil or paint. The FIGS. 8 and 10 show the CPA member 1 in the open state and the FIGS. 9 and 11 show the CPA member 1 in the closed state. By moving the CPA member 1 in the Z-direction relative to the circuit board 16, which is attached to the connector 3, the plate member 32 of the CPA member 1 engages respective ramp-formed sections 33 of both resilient members 9, 10, which are deflected until respective contact sections 34 of both resilient members 9, 10 slide along a surface of the plate member 32 and onto the contact bridge 12 when the CPA member 1 reaches the closed state, which is depicted in FIGS. 9 and 11. The resilient members 9, 10 establish an electric contact by contacting the contact bridge 12, thus connecting the electric circuit 8 when the CPA member 1 is in the closed state. The spring tension of the deflected resilient members 9, 10 press the conductor sections onto the contact bridge 12. The change of state of the electric circuit 8 by connecting the electric circuit 8 indicates that the CPA member 1 has been moved from the open state to the closed state, for example by sending a signal via the transmission antenna 27, which has been generated by the logic block 26. In an alternative embodiment, the change of state of the electric circuit 8 can be a discontinuation of the electric circuit 8, and the end of transmission of the signal indicates the closed state of the CPA member 1.

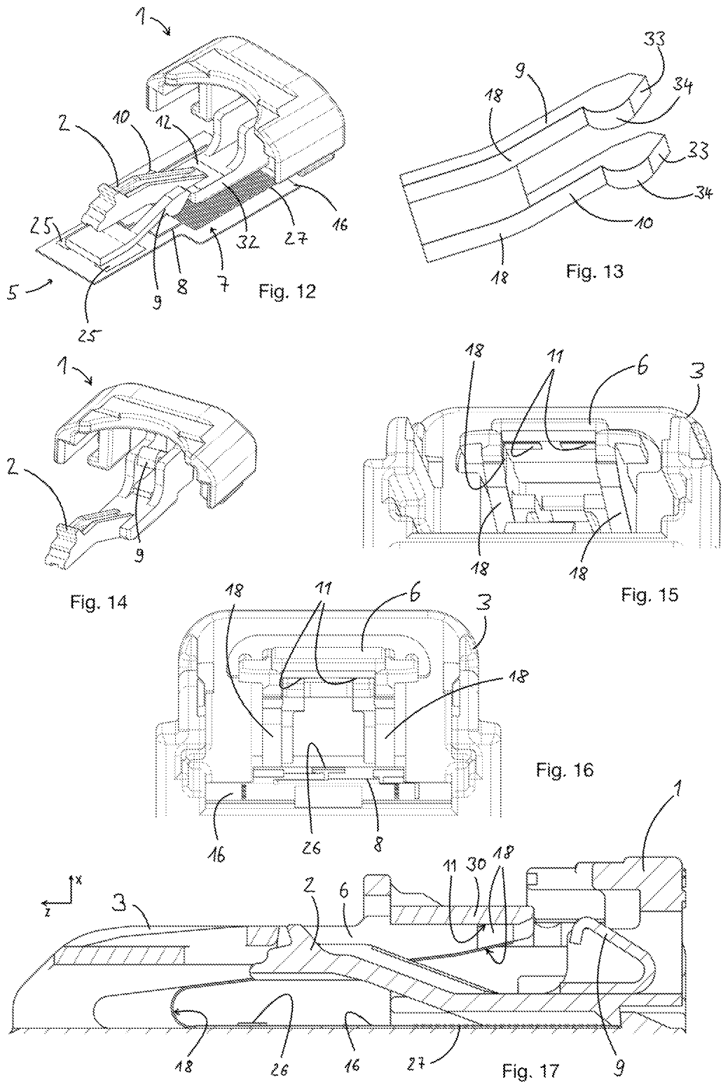

In FIG. 12, a CPA member 1 and a detection device 5 of a third embodiment of the connector arrangement is shown in a perspective view. The third embodiment differs from the above described second embodiment in the material of the resilient members 9, 10, which are depicted as a detail in FIG. 13. The resilient members 9, 10 are made of generally insulating material, like a plastic. The resilient members 9, 10 can be produced in one piece, for example by moulding. Respective conductive coatings 18 are applied on both resilient members 9, 10, which conductive coatings 18 form conductor sections of the electric circuit 8. The conductive coatings 18 are connected to the electric circuit 8 via the contact pads 25. The electric circuit 8 has the electrically isolated contact bridge 12 on the plate member 32 of the CPA member 1. The FIG. 12 shows the CPA member 1 in the open state. By moving the CPA member 1 in the Z-direction relative to the circuit board 16, which is attached to the connector 3, the plate member 32 of the CPA member 1 engages the respective ramp-formed sections 33 of both resilient members 9, 10, which are deflected until the respective contact sections 34 of both resilient members 9, 10 slide along a surface of the plate member 32 and onto the contact bridge 12 when the CPA member 1 reaches the closed state, which is not depicted. The conductive coatings 18 on the resilient members 9, 10 establish an electric contact by contacting the contact bridge 12, thus connecting the electric circuit 8 when the CPA member 1 is in the closed state. The spring tension of the deflected resilient members 9, 10 press the conductor sections formed by the conductive coatings 18 onto the contact bridge 12.

In FIG. 14, the CPA member 1 of a fourth embodiment of the connector arrangement is shown in a perspective view. FIGS. 15 and 16 show the connector 3 of the fourth embodiment in different perspective views. In the fourth embodiment, the two contact portions 11 are arranged on the connector 3 and the resilient member 9 is arranged on the CPA member 1. The two contact portions 11 can be applied to surfaces of the latching arm 6 of the connector 3 in the form of a conductive coating 18, the two contact portions 11 being connected to the electric circuit 8 on the circuit board 16, for example also via conductive coatings 18 applied to surfaces of the latching arm 6. The circuit board 16 is installed on the connector 3.

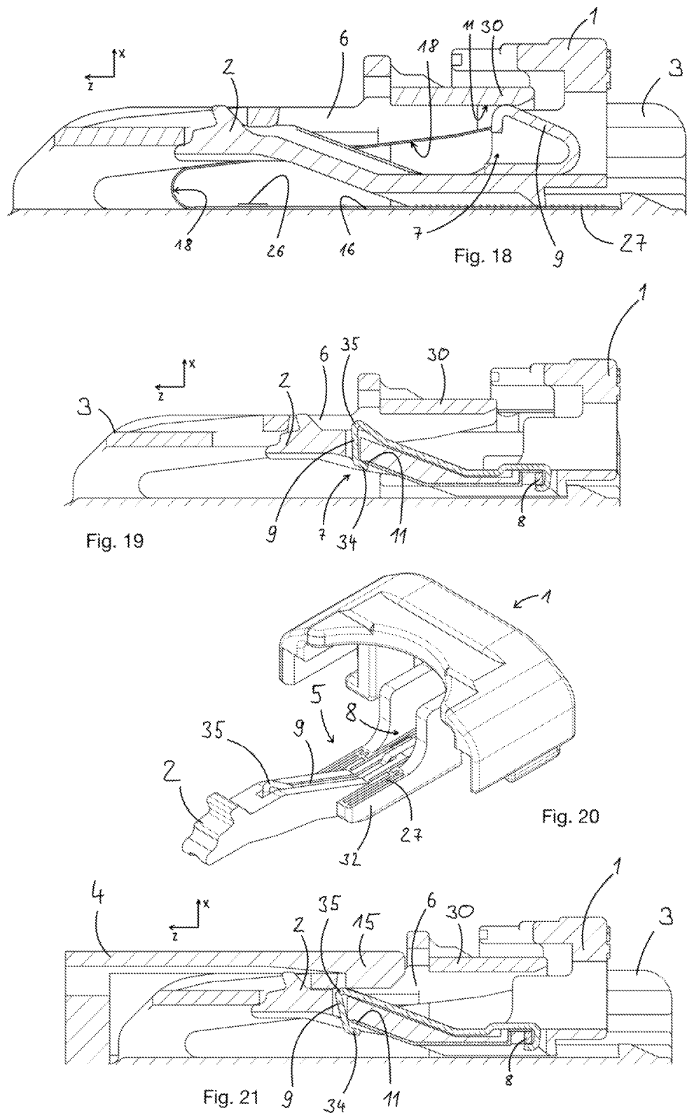

The detection device 5 is adapted to wirelessly indicate that the CPA member 1 has been moved from the open state to the closed state, which will be described with respect to FIGS. 17 and 18, which show the fourth embodiment of the connector arrangement with the CPA member 1 in the open state in FIG. 17 and in the closed state in FIG. 18, each depicted in a sectional view in a plane defined by the X and Z spatial directions. The connector 3 is only partly depicted as the terminal reception section 24 has been omitted. The mating connector 4 is not depicted. In the unmated position of the connector arrangement shown in FIG. 17, the CPA member 1 cannot be moved from the open state to the closed state. The single resilient member 9 of the detection device 5 is unbent and distanced from the contact portions 11 of the electric circuit 8 on the latching arm 6. In the mated position of the connector arrangement shown in FIG. 18 without the mating connector 4, the CPA member 1 has been moved in the Z-direction from the open state to the closed state. With the CPA member 1 in the closed state, the resilient member 9 is deflected by the free end 30 of the latching arm 6 and the spring tension of the deflected resilient member 9 presses the conductor section onto the two contact portions 11, bridging the contact portions 11 and thus closing the electric circuit 8. As the free end 30 of the latching arm 6 is blocked by the resilient member 9 in the X-direction, the CPA member 1 prevents the connector 3 and the mating connector 4 from accidental unmating. The change of state of the electric circuit 8 by connecting the electric circuit 8 indicates that the CPA member 1 has been moved from the open state to the closed state, in particular by sending a signal via the transmission antenna 27, which has been generated by the logic block 26. In an alternative embodiment, the change of state of the electric circuit 8 can be a discontinuation of the electric circuit 8, and the end of transmission of the signal indicates the closed state of the CPA member 1.

In FIG. 19, the connector with the CPA member of a fifth embodiment of the connector arrangement is shown in a sectional view. FIG. 20 shows the CPA member of FIG. 19 in a perspective view.

The detection device 5 of the fifth embodiment is integrated into the CPA member 1 and it is only attached to the CPA member 1. The electric circuit 8 is mostly disposed on the plate member 32, including the transmission antenna 27. The single resilient member 9 is a metal spring forming the conductor section, for example a solid metal wire, which is disposed in a slot on the arm 2. A protruding section 35 of the resilient member 9 protrudes from the slot. A contact section 34 is in contact with the single contact portion 11 of the electric circuit 8. According to the fifth embodiment, the electric circuit 8 is connected in the open state of the CPA member shown in FIG. 19. In FIG. 21, the fifth embodiment of the connector arrangement is shown with the CPA member 1 in the closed state in a sectional view. The CPA member 1 has been moved in the Z-direction from the open state to the closed state. With the CPA member 1 in the closed state, the resilient member 9 is deflected by the locking arm 15 of the mating connector 4, which interacts with the protruding section 35, thus lifting the contact section 34 from the contact portion 11 and discontinuing the electric circuit 8. The change of state of the electric circuit 8 by discontinuing the electric circuit 8 indicates that the CPA member 1 has been moved from the open state to the closed state, in particular by discontinuing a transmission of a signal transmitted via the transmission antenna 27.

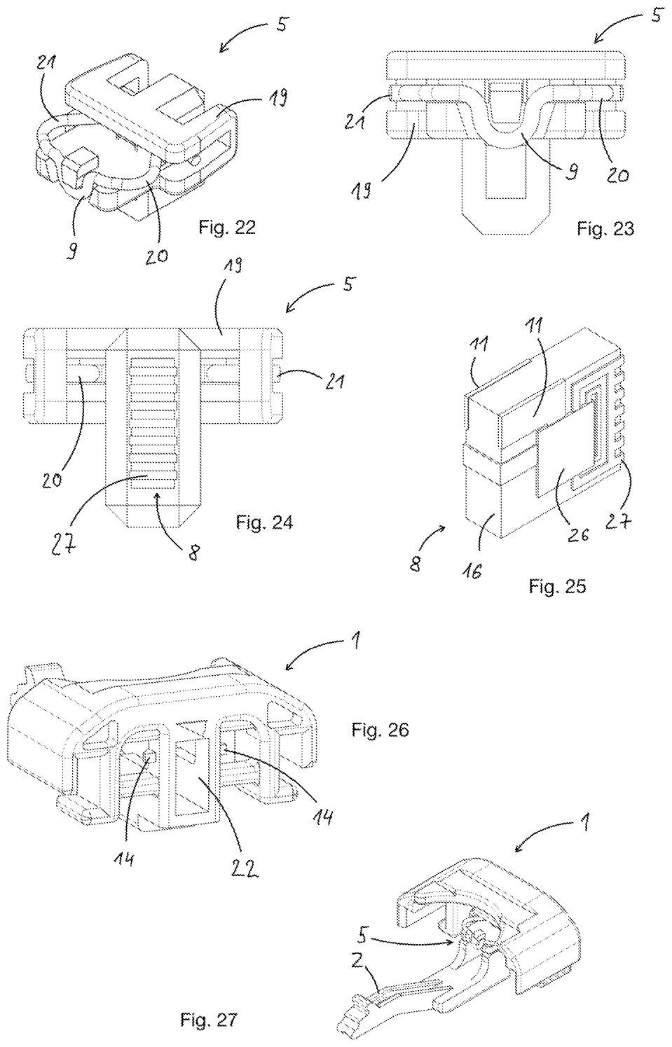

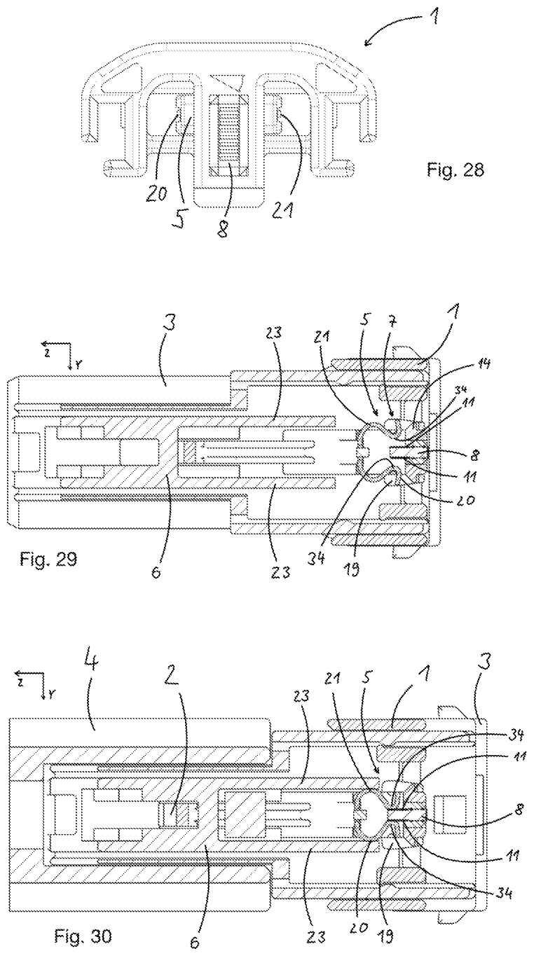

In FIGS. 22 to 24, a detection device 5 of a sixth embodiment is shown in different views. The detection device 5 is modular member, which can be installed on the CPA member 1, as will be illustrated with regard to FIGS. 26 to 28. FIG. 25 shows a detail of the detection device 5. The resilient member 9 has two legs 20, 21, the conductor section extending from a first leg 20 to a second leg 21, each leg 20, 21 being adapted to contact one of two contact portions 11. The resilient member 9 can be an electroconductive metal spring forming the conductor section. The resilient member 9 is attached to a module housing 19, which also accommodates the electric circuit 8. The electric circuit 8 is disposed on a compact circuit board 16 as illustrated in FIG. 25. The electric circuit 8 comprises the logic block 26, the transmission antenna 27 and two contact portions 11 disposed on opposite surfaces of the circuit board 16, which are electrically insulated from each other. One of the contact portions 11 is adapted to be contacted by the first leg 20 and the other one of the contact portions 11 is adapted to be contacted by the second leg 21, thus closing the electric circuit 8 via the resilient member 9. The modular detection device 5 is inserted into a slot 22 of the CPA member 1, which is depicted in FIG. 26 without the detection device 5. When the modular detection device 5 is mounted on the CPA member 1, the electric circuit 8 fills the slot 22 and the transmission antenna 27 is located at a surface of the CPA member 1, which advantageously increases the transmittable signal strength. The module housing 19 is fastened to the CPA member 1 by snap-fitting to the locking clips 14. The first and second legs 20, 21 extend into a free space in the CPA member 1 with contact sections 34 being arranged adjacently to the contact portions 11.

The detection device 5 is adapted to wirelessly indicate that the CPA member 1 has been moved from the open state to the closed state, which will be described with respect to FIGS. 29 and 30, which show the sixth embodiment of the connector arrangement with the CPA member 1 in the open state in FIG. 29 and in the closed state in FIG. 30, each depicted in a sectional view in a plane defined by the Y and Z spatial directions. In the unmated position of the connector arrangement shown in FIG. 29, the CPA member 1 cannot be moved from the open state to the closed state. The first and second legs 20, 21 of the resilient member 9 of the detection device 5 are unbent and extend in the section plane. The contact sections 34 of the first and second legs 20, 21 are arranged at a distance from the contact portions 11. The electric circuit 8 is thus open. In the mated position of the connector arrangement shown in FIG. 30, the mating connector has been mated with the connector 3 and the CPA member 1 has been moved in the Z-direction from the open state to the closed state. With the CPA member 1 in the closed state, the first and second legs 20, 21 of the resilient member 9 are deflected towards the contact portions 11 by latch side walls 23 of the latching arm 6 and the spring tension of the deflected first and second legs 20, 21 presses the conductor sections 34 onto the two contact portions 11, bridging the contact portions 11 and thus closing the electric circuit 8. The latch side walls 23 extend in planes parallel to plane defined by the X and Z spatial directions. The change of state of the electric circuit 8 by connecting the electric circuit 8 indicates that the CPA member 1 has been moved from the open state to the closed state, in particular by sending a signal via the transmission antenna 27, which is generated by the logic block 26.

### REFERENCE NUMERALS

1 CPA member
2 arm
3 connector
4 mating connector
5 detection device
6 latching arm
7 spring contact
8 electric circuit
9 resilient member
10 resilient member
11 contact portion
12 contact bridge
14 locking clip
15 locking arm
16 circuit board
17 base portions
18 conductive coating
19 module housing
20 leg, first leg
21 leg, second leg
22 slot
23 latch side wall
24 terminal reception section
25 contact pads
26 logic block, RFID tag
27 transmission antenna, RFID antenna
28 protrusion
29 beam
30 free end
31 head
32 plate member
33 ramp-formed section
34 contact section
35 protruding section
X, Y, Z spatial directions, cartesian coordinates

1. A connector arrangement comprising:
a connector and a corresponding mating connector configured to be mated with the connector,
a CPA member configured to be movable between an open state and a closed state, wherein in the closed state the CPA member is adapted to confirm a proper mating of the connector and the mating connector and prevents the connector and the mating connector from accidental unmating;
a detection device for detecting the closed state of the CPA member, the detection device comprising an electric circuit and a spring contact for connecting and disconnecting the electric circuit, the spring contact comprising a resilient member, wherein the resilient member is deflected by at least one of the connector and the mating connector when the CPA member is moved from the open state to the closed state, and wherein the resilient member comprises a conductor section of the electric circuit.

2. A connector arrangement comprising:
a connector and a corresponding mating connector configured to be mated with the connector,
a CPA member configured to be movable between an open state and a closed state, wherein in the closed state the CPA member is adapted to confirm a proper mating of the connector and the mating connector and prevents the connector and the mating connector from accidental unmating;
a detection device for detecting the closed state of the CPA member, the detection device comprising an electric circuit and a spring contact for connecting and disconnecting the electric circuit, the spring contact comprising a resilient member, wherein the resilient member is deflected by at least one of the connector and the mating connector when the CPA member is moved from the open state to the closed state, and wherein the resilient member comprises a conductor section of the electric circuit,
wherein the detection device is arranged on the CPA member only, the detection device being either a modular member connected to the CPA member or integrated into the CPA member.

3. The connector arrangement according to claim 2, wherein the detection device is partly arranged on the connector and on the CPA member.

4. The connector arrangement according to claim 2, wherein the electric circuit has two contact portions electrically isolated from each other, the resilient member being adapted to bridge the two contact portions, with the conductor section connecting or disconnecting the electric circuit when the CPA member is in the closed state.

5. The connector arrangement according to claim 4, wherein a spring tension of the deflected resilient member presses the conductor section onto the two contact portions or away from the two contact portions when the CPA member is in the closed state.

6. The connector arrangement according to claim 4, wherein the resilient member has two legs, the conductor section extending from one leg to the other leg, each leg being adapted to contact one of the two contact portions with the conductor section.

7. The connector arrangement according to claim 4, wherein the two contact portions are arranged on the connector and the resilient member is arranged on the CPA member.

8. A connector arrangement comprising:
a connector and a corresponding mating connector configured to be mated with the connector,
a CPA member configured to be movable between an open state and a closed state, wherein in the closed state the CPA member is adapted to confirm a proper mating of the connector and the mating connector and prevents the connector and the mating connector from accidental unmating;
a detection device for detecting the closed state of the CPA member, the detection device comprising an electric circuit and a spring contact for connecting and disconnecting the electric circuit, the spring contact comprising a resilient member, wherein the resilient member is deflected by at least one of the connector and the mating connector when the CPA member is moved from the open state to the closed state, and wherein the resilient member comprises a conductor section of the electric circuit,
wherein the electric circuit has two contact portions electrically isolated from each other, the resilient member being adapted to bridge the two contact portions, with the conductor section connecting or disconnecting the electric circuit when the CPA member is in the closed state,
wherein the electric circuit is at least in part disposed on a circuit board, the circuit board being arranged on the connector, wherein the two contact portions are attached to a latching arm of the connector, the two contact portions being connected to the electric circuit on the circuit board.

9. The connector arrangement according to claim 8, wherein the detection device has two resilient members, each resilient member comprising a conductor section of the electric circuit.

10. The connector arrangement according to claim 9, wherein the electric circuit has an electrically isolated contact bridge, the resilient members being adapted to establish an electric contact between the two conductor sections by contacting the contact bridge with both conductor sections, thus connecting or disconnecting the electric circuit when the CPA member is in the closed state.

11. The connector arrangement according to claim 9, wherein a spring tension of the deflected resilient members press the conductor sections onto the contact bridge or away from the contact bridge when the CPA member is in the closed state.

12. The connector arrangement according to claim 9, wherein the resilient members are arranged on the connector and that the contact bridge is arranged on the CPA member.

13. The connector arrangement according to claim 9, wherein the electric circuit is at least in part disposed on a circuit board, the two resilient members being attached to the circuit board, and the circuit board being arranged on the connector.

14. The connector arrangement according to claim 8, wherein at least one of the conductor sections, the bridge portion and the contact portions are provided as an electrically conductive coating.

15. The connector arrangement according to claim 8, wherein the resilient member is a metal spring in the form of a solid metal wire or a flat metal wire forming the conductor section.
